(19) United States
(12) Patent Application Publication
(10) Pub. No.: US 2025/0073644 A1
(43) Pub. Date: Mar. 6, 2025

(54) COMPOSITE NANOFILTRATION MEMBRANE CAPABLE OF EFFICIENTLY INTERCEPTING AMMONIUM SULFATE AND AMMONIUM NITRATE WHILE ADSORBING AND REMOVING MERCURY IONS AND PREPARATION METHOD THEREOF

(71) Applicant: NORTH CHINA ELECTRIC POWER UNIVERSITY (BAODING), Baoding (CN)

(72) Inventors: Runlong HAO, Baoding (CN); Jiabin GAO, Baoding (CN); Mengyuan WU, Baoding (CN); Xi CHEN, Baoding (CN)

(21) Appl. No.: 18/815,028

(22) Filed: Aug. 26, 2024

(30) Foreign Application Priority Data
Aug. 29, 2023 (CN) 202311097386.8

(51) Int. Cl. B01D 67/00; B01D 61/02; B01D 69/12; B01D 71/02; B01D 71/10

(52) U.S. Cl. CPC B01D 67/00793; B01D 61/027; B01D 69/12; B01D 71/0212; B01D 71/0221; B01D 71/10; B01D 2323/12

(57) ABSTRACT

Disclosed are a composite nanofiltration membrane for efficiently intercepting ammonium sulfate and ammonium nitrate and simultaneously adsorbing and removing mercury ions and a preparation method thereof, belonging to the technical field of industrial exhaust gas purification, wastewater purification and treatment and resource utilization. The preparation method of the composite nanofiltration membrane, comprising following steps: adding a cellulose nano fibrils colloid and a carboxylated carbon nanotubes-sodium dodecyl sulfate colloid into an MXene few layer dispersion solution to obtain a mixed dispersion solution, filtering the mixed dispersion solution in vacuum to a surface of a nanofiltration membrane, and standing and drying at room temperature to obtain a composite nanofiltration membrane.

### CROSS-REFERENCE TO RELATED APPLICATIONS

This application claims priority to Chinese Patent Application No. 202311097386.8, filed on Aug. 29, 2023, the contents of which are hereby incorporated by reference.

### TECHNICAL FIELD

The present disclosure belongs to the technical field of industrial exhaust gas purification, wastewater purification and treatment and resource utilization, and particularly relates to a composite nanofiltration membrane capable of efficiently intercepting ammonium sulfate and ammonium nitrate while adsorbing and removing mercury ions and a preparation method thereof.

### BACKGROUND

Coal remains the main source of energy consumption in the current energy structure and power structure, although the demand for energy is increasing with the development of industry and the improvement of people's living standards. Fume generated from coal combustion contains a variety of harmful pollutants, including SO₂, NOₓ, Hg⁰, etc., which cause extremely serious harm to the atmospheric environment. Therefore, it is imperative to reduce pollution from coal-fired flue gases in today's atmosphere. Novel catalysts have been developed to promote efficient catalytic oxidation of ammonium sulfite/ammonium nitrite present in desulfurization and denitrification slurries. However, it is still a challenge to enrich the oxidized (NH₄)₂SO₄ and NH₄NO₃ generated in the slurry for harmless wastewater resourcing (evaporation and crystallization into composite fertilizers for sustainable development of green economy).

During the removal of SO₂ and NOₓ from the flue gas using the above process, Hg⁰ in the flue gas is also absorbed by the desulfurization and denitrification slurry and stored in the slurry in the form of Hg(II), which is also concentrated during the enrichment of (NH₄)₂SO₄ and NH₄NO₃ in the flue gas. Mercury poisoning, often called “Minamata disease”, is a form of neurotoxicity that causes generalized neurological damage, resulting in nerve damage, chromosomal mutations and respiratory difficulties, to name a few. There are also a large number of studies on Hg(II) adsorbents in the prior art, such as metal oxides, mesoporous silicon-based materials, etc., all of which show high adsorption capacity for Hg(II). Existing literature (Das, S., Samanta, A., Kole, K., Gangopadhyay, G., Jana, S., 2020. MnO₂ flowery nanocomposites for efficient and fast removal of mercury(II) from aqueous solution: a facile strategy and mechanistic interpretation. Dalton Trans. 4920, 6790-6800.) achieved the adsorption of Hg(II) in polluted water by growing MnO₂ nanoflowers on the surface of clay nanomaterials at pH=7, but the adsorption amount reached only 361.8 milligrams per gram (mg·g⁻¹); while in another reference (Awual, M.R., 2017. Novel nanocomposite materials for efficient and selective mercury ions capturing from wastewater. Chem. Eng. J. 307, 456-465.), a mesoporous silica was proposed, and its adsorption amount of Hg(II) in water was only 179.7 mg·g⁻¹. Thus, it may be seen that the existing adsorbents are still unable to meet the requirement of efficient adsorption of Hg(II). Accordingly, it is clear that the existing adsorbents are still unable to meet the requirements for efficient adsorption of Hg(II).

Therefore, it is important to remove Hg(II) from the concentrated slurry while enriching (NH₄)₂SO₄ and NH₄NO₃.

### SUMMARY

In order to solve the above technical problems, the present disclosure provides a composite nanofiltration membrane capable of efficiently intercepting ammonium sulfate and ammonium nitrate while adsorbing and removing mercury ions and a preparation method thereof. The composite nanofiltration membrane prepared by the present disclosure is capable of adsorbing and removing Hg(II) in concentrated slurry while ensuring a high interception effect on NO₃⁻, SO₄²⁻ and NH₄⁺, so as to achieve harmless treatment and resource utilization of wastewater. Moreover, the enriched (NH₄)₂SO₄ and NH₄NO₃ may be further evaporated and crystallized to generate nitrogen fertilizer, thus realizing the resource utilization of (NH₄)₂SO₄ and NH₄NO₃ economically and efficiently and realizing the sustainable development of green economy. In addition, the process involved in the preparation method of the composite nanofiltration membrane of the present disclosure is simple and non-toxic and environmentally friendly, which makes it suitable for popularization and application.

In order to achieve the above objectives, the present disclosure provides the following technical schemes.

One of the technical schemes of the present disclosure provides a preparation method of a composite nanofiltration membrane, including following steps: adding a cellulose nano fibrils colloid (CNF colloid) and a carboxylated carbon nanotubes-sodium dodecyl sulfate colloid (MCCNTs-SDS colloid) into an MXene few layer dispersion solution to obtain a mixed dispersion solution, filtering the mixed dispersion solution in vacuum to a surface of the nanofiltration membrane, and standing and drying at room temperature to obtain a composite nanofiltration membrane (MXene/MCCNTs-SDS/CNF/NF-90 composite nanofiltration membrane); and
a preparation method of the MXene few layer dispersion solution includes following steps: dissolving lithium fluoride with hydrochloric acid solution, then adding Ti₃AlC₂ for stirring treatment to realize etching, then performing ultrasonic treatment and centrifugation, adding ethanol into a precipitate to continue ultrasonic treatment for 1 hour (h) to obtain MXene few layer nanosheets, and centrifuging at 3500-5000 revolutions per minute (r/min) to obtain the MXene few layer dispersion solution.

Optionally, a preparation method of the CNF colloid includes following steps: dissolving 10 g of CNF in 40 milliliter (mL) of deionized water, stirring for 3 h, and performing ultrasonic treatment with an ultrasonic power of 750 Watts (W) for 1 h to obtain the CNF colloid.

Optionally, a preparation method of the MCCNTs-SDS colloid includes following steps: weighing 0.1 g of carboxylated carbon nanotubes and 0.2 g of sodium dodecyl sulfate and adding into 50 mL of deionized water to obtain a mixture, and performing ultrasonic treatment on the mixture at an ultrasonic power of 750 W for 2 h to obtain the MCCNTs-SDS colloid.

Optionally, a concentration of the MXene few layers dispersion solution is 2 mg/mL, and a volume ratio of the MXene few layers dispersion solution to the carboxylated carbon nanotubes-sodium dodecyl sulfate colloid and the cellulose nano fibrils colloid is 5:4:1.

Optionally, a material-liquid ratio of the lithium fluoride, the Ti₃AlC₂ and the hydrochloric acid solution is 2 g:2 g:40 mL, and a concentration of the hydrochloric acid solution is 9 mole per liter (mol/L).

Optionally, a stirring temperature of adding the Ti₃AlC₂ for stirring treatment is in a range of 30 degrees Celsius (° C.)-35° C., a rotating speed is 450 r/min, and an etching duration is in a range of 24-48 h. More optionally, the stirring temperature is 35° C. and the etching duration is 24 h.

Optionally, after the stirring treatment and etching, the ultrasonic treatment and centrifugation are carried out until a pH of a supernatant is higher than 6.

Optionally, a power of ultrasound in a preparation process of the MXene few layers dispersion solution is 750 W.

Optionally, a pressure of the filtering in vacuum is 0.5 mega pascal (MPa).

Optionally, the nanofiltration membrane is an NF-90 membrane.

Another technical scheme of the present disclosure provides a composite nanofiltration membrane prepared by the preparation method.

Another technical scheme of the present disclosure provides an application of the composite nanofiltration membrane in intercepting ammonium sulfate ((NH₄)₂SO₄) and ammonium nitrate (NH₄NO₃) in desulfurization and denitrification slurry while adsorbing and removing mercury ions (Hg(II)).

Compared with the prior art, the present disclosure has the following advantages and technical effects.

The composite nanofiltration membrane of the present disclosure takes the MXene few layer dispersion solution, MCCNTs-SDS colloid and CNF colloid as raw materials, while the MXene in the MXene few layer dispersion solution has film-forming property, and the terminal groups of MXene are capable of forming irreversible self-crosslinking Ti—O—Ti bonds between neighboring nanosheets, which exhibits good anti-swelling properties in water. After the addition of MCCNTs-SDS colloids, the strong π-π interactions and van der Waals forces promote the formation of connections between MXene nanosheets and carboxylated carbon nanotubes via covalent bonds, which prompts the MXene nanosheets to be tightly adhered to each other, thus enhancing the anti-swelling properties and interfacial bonding strength. Also, the modified MCCNTs-SDS colloids with high mechanical strength serve as supporting pillars within the neighboring MXene nanosheets, thus enlarging the d-spacing of the membranes and improving the compressive properties of the membranes.

The composite nanofiltration membrane developed in the present disclosure has achieved a breakthrough in monovalent salt retention performance compared to classical commercial membranes and composite nanofiltration membranes in the prior art. The retention of salt ions by the composite nanofiltration membrane of the present invention attributes to the synergistic effect of Donnan effect and size rejection. The synergistic effect between Donnan effect and dielectric repulsion effect of membranes composed of MXene, MCCNTs-SDS and CNF is helpful to improve the rejection efficiency of commercial nanofiltration membrane NF-90 for divalent ions (SO₄²⁻) and achieve 100% rejection of SO₄²⁻. According to the composite nanofiltration membrane of the present disclosure, the electrostatic repulsion of commercial NF-90 membrane is enhanced, which is conducive to the utilization of the Donnan effect to promote the exclusion of monovalent ions (NO₃⁻), and the retention efficiency of NO₃⁻ may be increased from 20.7% of the NF-90 membrane to 84.5%, and the enriched (NH₄)₂SO₄ and NH₄NO₃ may be further evaporated and crystallized to produce nitrogen fertilizers, thus economically and efficiently realizing the resourceful utilization of (NH₄)₂SO₄, NH₄NO₃, and achieving sustainable development of green economy.

Compared with traditional adsorption materials, the MXene in the MXene few layer dispersion solution prepared by the present disclosure has larger specific surface area, rich —OH and —O functional groups and adjustable surface chemical properties, which not only provides a site for surface complexation and ion exchange with Hg(II), but also acts as a reducing agent for Hg(II), and the in-situ reduction ability of this combined adsorption is superior to many other nano-material adsorbents. The theoretical maximum removal capacity of the composite nanofiltration membrane prepared by the present disclosure for Hg(II) is 2,869.6 mg·g⁻¹, and the composite nanofiltration membrane has excellent Hg(II) removal performance, which is of great significance for reducing secondary pollution of water bodies.

The MXene/MCCNTs-SDS/CNF/NF-90 nanofiltration membrane prepared by the present disclosure may be recycled, and the nanofiltration membrane still has good interception efficiency (84.5% for NO₃⁻, 93.6% for SO₄²⁻ and 89.6% for NH₄⁺) after 10 cycles, suggesting a broad application prospect.

The preparation method of the composite nanofiltration membrane involves a simple process and is non-toxic, environmentally friendly and suitable for popularization and application.

### BRIEF DESCRIPTION OF THE DRAWINGS

The accompanying drawings, which constitute a part of this application, are used to provide a further understanding of this application. The illustrative embodiments of this application and their descriptions are used to explain this application, and do not constitute an improper limitation of this application. In the attached drawings:

FIG. 1 is an X-ray Photoelectron Spectroscopy (XPS) diagram of MXene/MCCNTs-SDS/CNF/NF-90 composite nanofiltration membrane prepared in Embodiment 1 of the present disclosure;

FIG. 2 shows an X-ray diffraction (XRD) pattern of the MXene/MCCNTs-SDS/CNF/NF-90 composite nanofiltration membrane prepared in Embodiment 1 of the present disclosure;

FIG. 3A shows a scanning electron microscope (SEM) image of a surface of the MXene/MCCNTs-SDS/CNF/NF-90 composite nanofiltration membrane prepared in Embodiment 1 of the present disclosure;

FIG. 3B shows an SEM image of a cross-section of the MXene/MCCNTs-SDS/CNF/NF-90 composite nanofiltration membrane prepared in Embodiment 1 of the present disclosure;

FIG. 4 is an XRD diagram of the MXene few layers dispersion solution prepared in Comparative embodiment 1;

FIG. 5 is a transmission electron microscope (TEM) diagram of MXene few layers dispersion solution prepared in Comparative embodiment 1;

FIG. 6A is an SEM image of a surface of MXene/CNF/NF-90 composite nanofiltration membrane prepared in Comparative embodiment 1;

FIG. 6B is an SEM image of a cross-section of MXene/CNF/NF-90 composite nanofiltration membrane prepared in Comparative embodiment 1;

FIG. 7A is an SEM image of a surface of MXene/MCCNTs/CNF/NF-90 composite nanofiltration membrane of Comparative embodiment 2;

FIG. 7B is an SEM image of a cross-section of MXene/MCCNTs/CNF/NF-90 composite nanofiltration membrane of Comparative embodiment 2; and

FIG. 8 shows the saturated adsorption capacity of MXene/MCCNTs-SDS/CNF/NF-90 composite nanofiltration membrane prepared in Embodiment 1 at different initial Hg(II) concentrations.

### DETAILED DESCRIPTION OF THE EMBODIMENTS

A number of exemplary embodiments of the present disclosure will now be described in detail, and this detailed description should not be considered as a limitation of the present disclosure, but should be understood as a more detailed description of certain aspects, characteristics and embodiments of the present disclosure.

It should be understood that the terminology described in the present disclosure is only for describing specific embodiments and is not used to limit the present disclosure. In addition, for the numerical range in the present disclosure, it should be understood that each intermediate value between the upper limit and the lower limit of the range is also specifically disclosed. The intermediate value within any stated value or stated range and every smaller range between any other stated value or intermediate value within the stated range are also included in the present disclosure. The upper and lower limits of these smaller ranges may be independently included or excluded from the range.

Unless otherwise specified, all technical and scientific terms used herein have the same meaning as commonly understood by one of ordinary skill in the art to which this present disclosure relates. Although the present disclosure only describes the preferred methods and materials, any methods and materials similar or equivalent to those described herein may also be used in the practice or testing of the present disclosure. All documents mentioned in this specification are incorporated by reference to disclose and describe methods and/or materials related to the documents. In case of conflict with any incorporated document, the contents of this specification shall prevail.

It is obvious to those skilled in the art that many improvements and changes may be made to the specific embodiments of the present disclosure without departing from the scope or spirit of the present disclosure. Other embodiments will be apparent to the skilled person from the description of the present disclosure. The description and embodiments of that present disclosure are exemplary only.

The terms “including”, “comprising”, “having” and “containing” used in this specification are all open terms, which means including but not limited to.

All the raw materials used in the embodiments of the present disclosure are commercially available, and the commercial nanofiltration membrane NF-90 is purchased from Ande Membrane Seperation Technology Engineering (Beijing) Co., Ltd. In addition, the steps of filtering in vacuum, ultrasonic treatment, centrifugal treatment and the like in the preparation process of the embodiments of the present disclosure are all conventional technical means in the field, and are not taken as limitations to the technical scheme of the present disclosure.

The existing nanofiltration membranes in Comparative embodiment 4 are prepared according to methods disclosed in the literature (H. Zheng, Z. Mou, Y.J. Lim, B. Liu, R. Wang, W. Zhang, K. Zhou, Incorporating ionic carbon dots in polyamide nanofiltration membranes for high perm-selectivity and antifouling performance, J. Membr. Sci., 672 (2023) 121401).

The room temperature in the embodiments of the present disclosure refers to 25+/−2° C.

The technical schemes of the present disclosure are further explained by embodiments.

### Embodiment 1

1) Preparation of MXene few layer dispersion solution: 2 g of lithium fluoride is added into 40 mL of 9 mol/L hydrochloric acid solution, and then 2 g of Ti₃AlC₂ is slowly added into the above solution, and then stirred and etched (35° C., 24 h, rotation speed of 450 r/min), and then ultrasonic centrifugation is carried out to make the pH of the supernatant higher than 6, then 40 mL of ethanol is added into the precipitate, and ultrasonic treatment is carried out for 1 h (750 W), so as to obtain MXene few layer nanosheets, and then centrifugation (3500-5000 r/min) is carried out to obtain the MXene few layer dispersion solution with a concentration of 2 mg/mL;
2) preparation of CNF colloid: 10 g of cellulose nano fibrils are taken and dissolved in 40 mL of deionized water, stirred for 3 h, and ultrasonicated with ultrasonic power of 750 W for 1 h to obtain CNF colloid;
3) preparation of MCCNTs-SDS colloid: 0.1 g of carboxylated carbon nanotubes (MCCNTs) and 0.2 g of sodium dodecyl sulfate (SDS) are weighed and added into 50 mL of deionized water, and the mixture is subjected to ultrasonic treatment with ultrasonic power of 750 W for 2 h to obtain the MCCNTs-SDS colloid; and
4) 4 mL of MCCNTs-SDS colloid prepared in step 3) and 1 mL of CNF colloid prepared in step 2) are taken and dispersed in 5 mL of the MXene few layer dispersion solution prepared in step 1) to obtain a mixed dispersion solution, the above mixed dispersion solution is filtered onto the surface of a commercial nanofiltration membrane NF-90 by filtering in vacuum (with a pressure of 0.5 MPa), and left to stand for 30 min at room temperature, and then dried naturally to obtain MXene/MCCNTs-SDS/CNF/NF-90 composite nanofiltration membrane.

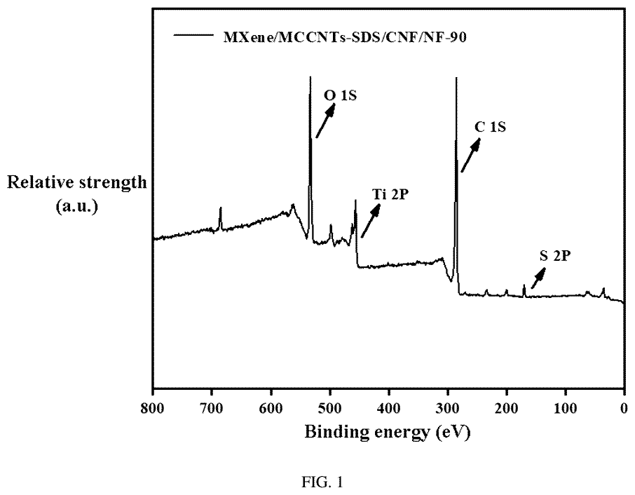

X-ray photoelectron spectroscopy (XPS) is used to analyze the elemental chemical composition and chemical valence state of MXene/MCCNTs-SDS/CNF/NF-90 composite nanofiltration membrane prepared in Embodiment 1 of the present disclosure, and the XPS results are shown in FIG. 1, and it is clearly observed from the FIG. 1 that there are four characteristic peaks of MXene/MCCNTs-SDS/CNF/NF-90 composite nanofiltration membrane, namely C 1s (284.8 electron volts (eV)), O 1s (533.2 eV), Ti 2p (455.9 eV) and S 2p (170.3 eV), The higher oxygen-carbon ratio (O/C) indicates that the MCCNTs containing abundant oxygen-containing functional groups are successfully bound to MXene, and the detection of the S 2p peak also confirms the successful deposition of SDS on the membrane.

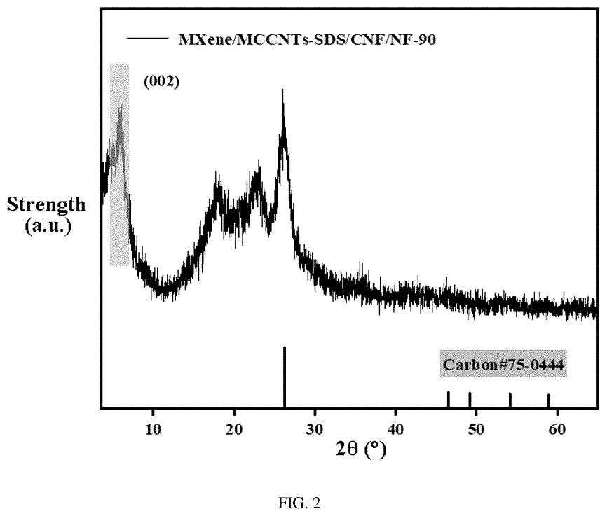

The MXene/MCCNTs-SDS/CNF/NF-90 composite nanofiltration membrane prepared in Embodiment 1 of the present disclosure is characterized by X-ray diffraction (XRD), and the XRD pattern results are shown in FIG. 2. From FIG. 2, it is observed that there is a characteristic (002) plane diffraction peak of MXene at 2θ=5.36°, and a new diffraction peak appears at 2θ=26.31°. Compared with XRD card (PDF #75-0444), it is found that the diffraction peak corresponds to the (111) crystal plane of C, and there are typical peaks of MXene and carbon in the composite membrane, which shows that MCCNTs has been successfully introduced into nanofiltration membrane, and its addition does not affect the stacking order of MXene along the direction.

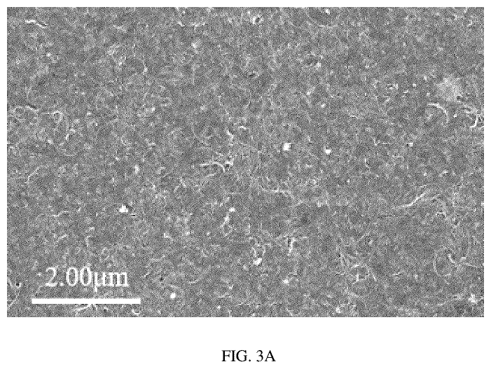

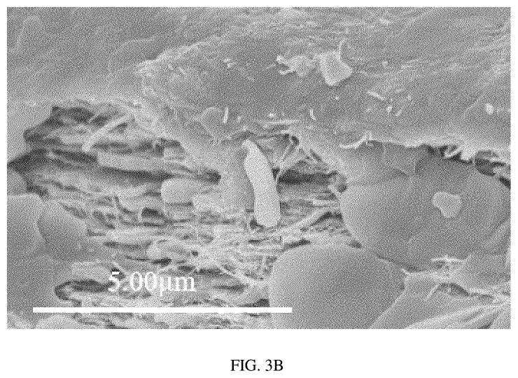

The surface and cross-section of MXene/MCCNTs-SDS/CNF/NF-90 composite nanofiltration membrane prepared in Embodiment 1 of the present disclosure are characterized by scanning electron microscopy (SEM). The SEM results are shown in FIG. 3A and FIG. 3B, where FIG. 3A is the surface and FIG. 3B is the cross-section. As can be seen from FIG. 3A and FIG. 3B, the embedding of MCCNTs into adjacent MXene nanosheets not only promotes the close connection between MXene nanosheets, but also enlarges the interlayer spacing of the membrane and ensures a certain water flux. In addition, to enhance the dispersibility of the CNTs in solution, surfactant SDS is employed to disperse and suspend CNTs with the assistance of ultrasound. The MXene/MCCNTs-SDS/CNF/NF-90 composite nanofiltration membrane exhibits the smooth surface, which due to the fact that the presence of SDS could effectively avoid structural defects and mechanical performance degradation caused by chemical oxidation. By introducing surfactant SDS, the MWCNTs-SDS colloid with high mechanical strength may act as pillars between the MXene nanosheets, expanding the interlayer spacing and enhancing the compressive performance of the membrane. The variation in interlayer distance is a crucial factor contributing to the differences in permeability, selectivity, and adsorption capacity of NF membranes.

### Comparative Embodiment 1

1) Preparation of MXene few layer dispersion solution: 2 g of lithium fluoride is added into 40 mL of 9 mol/L hydrochloric acid solution, and then 2 g of Ti₃AlC₂ is slowly added into the above solution, and then stirred and etched (35° C., 24 h, rotation speed of 450 r/min), and then ultrasonic centrifugation is carried out to make the pH of the supernatant higher than 6, then 40 mL of ethanol is added into the precipitate, and ultrasonic treatment is carried out for 1 h (750 W), so as to obtain MXene few layer nanosheets, and then centrifugation (3500-5000 r/min) is carried out to obtain the MXene few layer dispersion solution with a concentration of 2 mg/mL;
2) preparation of CNF colloid: 10 g of cellulose nano fibrils are taken and dissolved in 40 mL of deionized water, stirred for 3 h, and ultrasonicated with ultrasonic power of 750 W for 1 h to obtain CNF colloid; and
3) 1 mL of CNF colloid prepared in step 2) is taken and dispersed in 5 mL of MXene few layer dispersion solution prepared in step 1) to obtain a mixed dispersion, and the mixed dispersion is filtered onto the surface of a commercial nanofiltration membrane NF-90 by filtering in vacuum (at a pressure of 0.5 MPa), and then left to stand at room temperature for 30 min, and then dried naturally to obtain the MXene/CNF/NF-90 composite nanofiltration membrane.

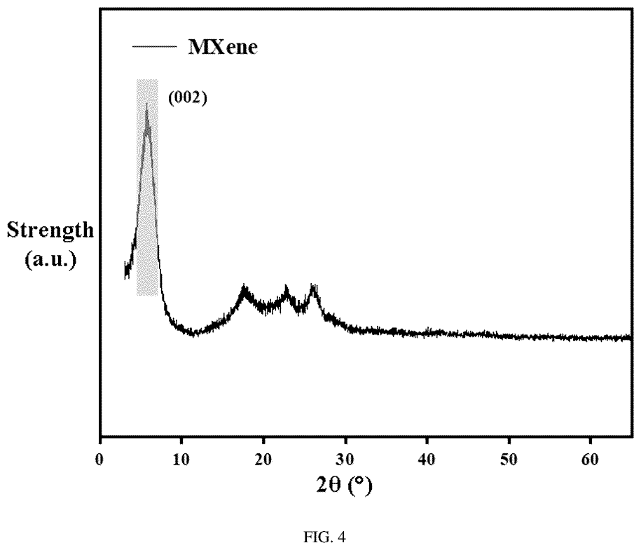

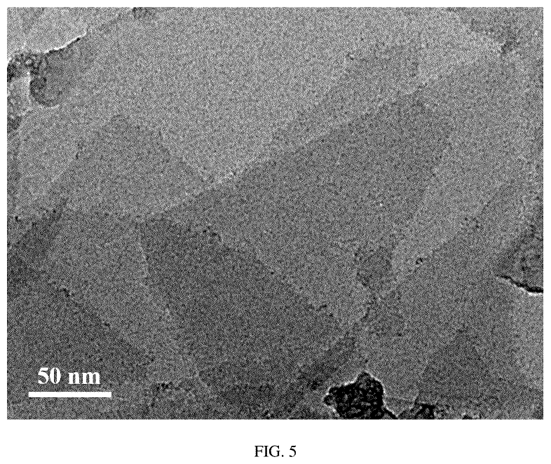

XRD is used to characterize the MXene few layers dispersion solution prepared in Comparative embodiment 1 of the present disclosure, and the XRD results are shown in FIG. 4. As may be seen from the FIG. 4, there is only one peak at 2θ=5.71°, which corresponds to the characteristic (002) plane of MXene, indicating that the preparation of MXene is successful. Further, the morphology and structure of the MXene few layers dispersion solution prepared in Comparative embodiment 1 of the present disclosure are characterized by TEM, and the TEM results are shown in FIG. 5, which shows that the MXene nanosheets are successfully exfoliated with proper delamination and stacking of the exfoliated nanosheets.

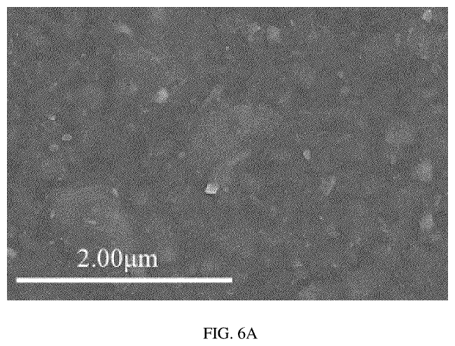

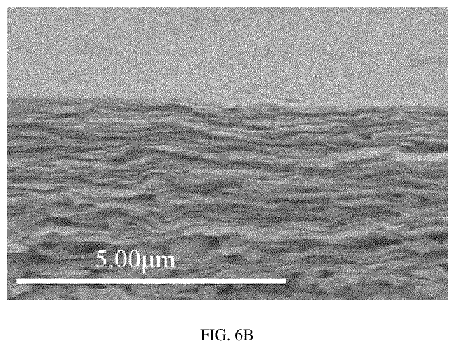

The surface and cross-section of the MXene/CNF/NF-90 composite nanofiltration membrane prepared in Comparative embodiment 1 of the present disclosure are characterized by SEM. The SEM results are shown in FIG. 6A and FIG. 6B, where FIG. 6A is the surface and FIG. 6B is the cross-section, and it may be observed that the MXene nanosheets are stacked in layers, and the membrane spacing is relatively small, suggesting that high pressure operation (the pressure of filtering in vacuum is 0.5 MPa) may lead to the dense accumulation of MXene nanosheets, thus reducing the water flux of nanofiltration membrane.

Comparative Embodiment 2
1) Preparation of MXene few layer dispersion solution: 2 g of lithium fluoride is added into 40 mL of 9 mol/L hydrochloric acid solution, and then 2 g of Ti₃AlC₂ is slowly added into the above solution, and then stirred and etched (35° C., 24 h, rotation speed of 450 r/min), and then ultrasonic centrifugation is carried out to make the pH of the supernatant higher than 6, then 40 mL of ethanol is added into the precipitate, and ultrasonic treatment is carried out for 1 h (750 W), so as to obtain MXene few layer nanosheets, and then centrifugation (3500-5000 r/min) is carried out to obtain the MXene few layer dispersion solution with a concentration of 2 mg/mL;
2) preparation of CNF colloid: 10 g of cellulose nano fibrils are taken and dissolved in 40 mL of deionized water, stirred for 3 h, and ultrasonicated with ultrasonic power of 750 W for 1 h to obtain CNF colloid; and
3) preparation of MCCNTs solution: 0.1 g of carboxylated carbon nanotubes (MCCNTs) is weighed and added into 50 mL deionized water, and ultrasonic treatment is performed on the mixture with ultrasonic power of 750 W for 2 h to obtain the MCCNTs solution; and
4) 4 mL of MCCNTs solution prepared in step 3) and 1 mL of CNF colloid prepared in step 2) are weighed and dispersed in 5 mL of MXene few layer dispersion solution prepared in step 1) to obtain a mixed dispersion solution, and the mixed dispersion solution is filtered to the surface of commercial nanofiltration membrane NF-90 by filtering in vacuum (pressure is 0.5 MPa), and left stand at room temperature for 30 min, and then naturally dried to obtain MXene/MCCNTs/CNF/NF-90 composite nanofiltration membrane.

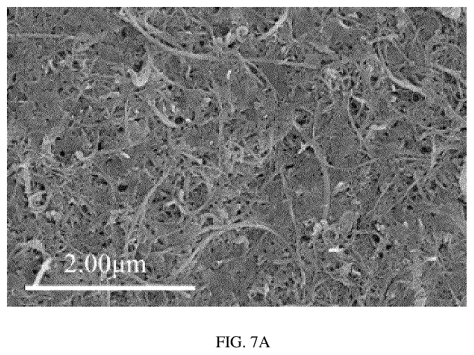

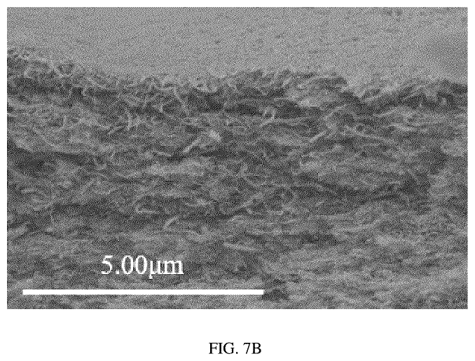

The surface and cross-section of the MXene/MCCNTs/CNF/NF-90 composite nanofiltration membrane of Comparative embodiment 2 of the present disclosure are characterized by SEM. The SEM results are shown in FIG. 7A and FIG. 7B, where FIG. 7A is the surface and FIG. 7B is the cross-section, and it is observed that MCCNTs are irregularly distributed on the surface and interlayer of the membrane, which shows that MCCNTs may act as pillars in adjacent MXene nanosheets to expand the interlayer spacing of the membrane and improve the compression resistance of the membrane. With the addition of MCCNTs, the spacing between membrane layers is enlarged, and the water flux is also improved while the compression resistance of the membrane is improved, but the ion interception effect is not improved. Therefore, the electrostatic repulsion of the nanofiltration membrane is enhanced by adding anionic surfactant SDS, so that the efficient interception of NO₃⁻, SO₄²⁻ and NH₄⁺ is completed by using Donnan effect and dielectric repulsion.

### Comparative Embodiment 3 Commercial Nanofiltration Membrane

Nanofiltration membrane NF-90 (purchased from Ande Membrane Seperation Technology Engineering (Beijing) Co., Ltd.).

### Comparative Embodiment 4 Conventional Nanofiltration Membrane

Preparation of polyamide film (TFN-PS-CDs membrane) with anionic polyetherimide (PEI) with sulfonate groups carbon dots (PS-CDs):
(1) preparation of charged carbon dots PS-CDs: 2 g of cationic amino carbon dots (PEI-CDs) are added into 60 mL of ethanol, continuously stirred at 35° C., and then 2 g of PS are gradually added, and the temperature of dispersion solution is raised to 55° C. and held for 6 h, and reddish-brown precipitate is collected to obtain the PS-CDs;
(2) preparation of nanofiltration membrane: the microporous polysulfone (PSF) ultrafiltration substrate is cut into rectangles (6 cm×8 cm) and completely immersed in PS-CDs aqueous solution for 2 min to fully absorb nanoparticles; then, the excess aqueous solution on the active surface of the membrane is removed with a self-made air knife; after that, the substrate is quickly immersed in an n-hexane pool containing 1,3,5-benzenetricarbonyl trichloride (TMC) (0.15 wt %) for interfacial polymerization, and kept for 1 min to form a thin and dense polyamide layer containing carbon dots on the substrate surface; the prepared polyamide membrane is soaked in pure n-hexane solution to quench the reaction; finally, the polyamide layer is cured at a high temperature of 60° C. for 15 min to enhance the density of the polyamide layer and obtain TFN-PS-CDs membrane.

### Application Embodiment

Application of nanofiltration membrane in intercepting NO₃⁻, SO₄²⁻ and NH₄⁺ and adsorbing and removing Hg(II)

Application objects: composite nanofiltration membranes prepared in Embodiment 1 and Comparative embodiments 1 and 2, commercial nanofiltration membrane NF-90 in Comparative embodiment 3 and TFN-PS-CDs membrane in Comparative embodiment 4.

Experimental conditions: 0.1 g KNO₃ and 0.1 g (NH₄)₂SO₄ are dissolved in 47.5 mL deionized water, and then 2.5 mL HgCl₂ solution with a concentration of 1000 parts per million (ppm) is added to obtain a mixed solution, so that the concentration of Hg(II) in the mixed solution is 50 ppm, and the pH of the mixed solution is adjusted to 7. Then, the mixed solution is poured on the composite nanofiltration membrane prepared in Embodiment 1, Comparative embodiments 1 and 2 and the commercial nanofiltration membrane NF-90 in Comparative embodiment 3, respectively, and the nanofiltration experiment is carried out at a pressure of 0.5 MPa. When the nanofiltration effluent is 10 mL, the interception of NO₃⁻, SO₄²⁻ and NH₄⁺ by nanofiltration membranes and the adsorption effect of Hg(II) are tested.

NO₃⁻ detection: 0.5 mL of concentrated slurry and 0.5 mL of nanofiltration effluent are respectively taken and added into a 50 mL colorimeter tube, then 0.1 mL of 0.083 mol/L sulfamic acid solution is added, 1 mL of hydrochloric acid (1 mol/L) is added, and the volume is fixed to 50 mL, followed by well mixing, and then left to stand for 5 min, and the absorbance values of A₁ and A₂ are obtained with a spectrophotometer at the wavelengths of 220 nm and 275 nm, respectively, and the final absorbance value is obtained with the formula of A₁-2A₂, from which the nitrate concentration C₁ in the concentrated slurry and the nitrate concentration C₂ in the nanofiltration effluent are calculated, and the nitrate retention efficiency is calculated according to (C₁-C₂)/C₁;

NH₄⁺ detection: 0.25 mL of concentrated slurry and 0.25 mL of nanofiltration effluent are taken and added into a 50 mL colorimeter tube respectively, 1 mL of potassium sodium tartrate solution and 1 mL of ammonia nitrogen reagent are added and the volume is fixed to 50 mL, followed by well mixing and standing for 10 min, and the absorbance value is measured with the spectrophotometer at a wavelength of 420 nm, from which, the ammonium concentration in the concentrated slurry is calculated to be C₃ and that in nanofiltration effluent is calculated to be C₄ and the nitrate retention efficiency is calculated according to (C₃-C₄)/C₃;

SO₄²⁻ detection: 2.5 mL of concentrated slurry and 2.5 mL of nanofiltration effluent are taken and added into a 50 mL colorimetric tube respectively, with the volume fixed to 50 mL, and are poured into a beaker after well mixing, then 2.5 mL of stabilizer and 0.2 g of barium chloride are added, followed by stirring for 1 min and then standing for 4 min, and then the absorbance is measured by the spectrophotometer at a wavelength of 420 nm, from which the concentration of sulfate in the concentrated slurry is calculated to be C₅, and that in the nanofiltration effluent to be C₆, and the sulfate retention efficiency is calculated according to (C₅-C₆/C₅); Hg(II) detection: the initial Hg(II) concentration C₇ and the Hg(II) concentration C₈ after adsorption in the mixed solution are measured by X-ray fluorescence heavy metal analyzer, and the adsorption efficiency of the nanofiltration membrane for mercury ions in water is calculated according to (C₇-C₈)/C₇.

See Table 1 for the determination results of the rejection efficiency of NO₃⁻, SO₄²⁻ and NH₄⁺ and the adsorption efficiency of Hg(II) by the composite nanofiltration membranes prepared in Embodiment 1 and Comparative embodiments 1 and 2, the commercial nanofiltration membrane NF-90 in Comparative embodiment 3 and the TFN-PS-CDs membrane in Comparative embodiment 4, among which the results of the retention efficiency of NO₃⁻, SO₄²⁻ and NH₄⁺ and the adsorption efficiency of Hg(II) by TFN-PS-CDs membranes of Comparative embodiment 4 are obtained from the above references.

TABLE 1
Performance test results of nanofiltration membrane
in Embodiment 1 and Comparative embodiments 1-4

| | NO₃⁻ | SO₄²⁻ | NH₄⁺ | Hg(II) |
|---|---|---|---|---|
| | retention | retention | retention | adsorption |
| | efficiency | efficiency | efficiency | efficiency |
| Embodiment 1 | 84.5% | 99.8% | 89.6% | 93.4% |
| (MXene/MCCNTs- | | | | |
| SDS/CNF/NF-90) | | | | |
| Comparative | 18.9% | 90.9% | 69.5% | 89% |
| embodiment 1 | | | | |
| (MXene/ | | | | |
| CNF/NF-90) | | | | |
| Comparative | 0.14% | 92% | 51.2% | 91.6% |
| embodiment 2 | | | | |
| (MXene/ | | | | |
| MCCNTs/CNF/NF- | | | | |
| 90) | | | | |
| Comparative | 20.7% | 80.9% | 66.7% | 0 |
| embodiment 3 | | | | |
| (NF-90) | | | | |
| Comparative | 19.8% | 99.4% | 18% | — |
| embodiment 4 | | | | |
| (TFN-PS-CDs | | | | |
| membrane) | | | | |

As can be seen from Table 1, compared with the MXene/CNF/NF-90 composite nanofiltration membrane prepared in Comparative embodiment 1, the MXene/MCCNTs/CNF-90 composite nanofiltration membrane prepared in Comparative embodiment 2, the commercial nanofiltration membrane NF-90 in Comparative embodiment 3 and the TFN-PS-CDs membrane in Comparative embodiment 4, the retention efficiencies of MXene/MCCNTs-SDS/CNF/NF-90 composite nanofiltration membranes prepared in Embodiment 1 of the present disclosure for NO₃⁻, SO₄²⁻ and NH₄⁺ are significantly improved. The reason for this is that SDS an anionic surfactant that modifies MCCNTs, and the SDS-modified MCCNTs are mixed with MXene, so as to enhance the electrostatic repulsion of the nanofiltration membrane, and facilitate the use of the Donnan effect and dielectric repulsion to accomplish the high efficiency of the retention of NO₃⁻, SO₄²⁻ and NH₄⁺.

Meanwhile, the adsorption effect of the MXene/MCCNTs-SDS/CNF/NF-90 composite nanofiltration membrane prepared in Embodiment 1 of the present disclosure on Hg(II) is increased from 0 to 93.4% as compared to the commercial nanofiltration membrane NF-90 of Comparative embodiment 3. This is attributed to the fact that the MXene, which is rich in surface functional groups, provides a site of surface complexation and ion-exchange with Hg(II), thus enabling the nanofiltration membrane to have highly superior Hg(II) adsorption performance.

The adsorption capacity of MXene/MCCNTs-SDS/CNF/NF-90 composite nanofiltration membrane prepared in Embodiment 1 of the present disclosure is tested at different temperatures (288 Kelvins (K), 298 K and 308 K) and different concentrations of Hg(II). Specifically, the MXene/MCCNTs-SDS/CNF/NF-90 composite membranes prepared in Embodiment 1 are added to 50 mL of Hg(II) solutions with different concentrations and the pH of the solutions is adjusted to 7; these solutions are placed in thermostatic water baths at 15° C. (288 K), 25° C. (298 K) and 35° C. (308 K) respectively, and left to stand for 48 h. The concentration changes of Hg(II) before and after adsorption is measured to calculate the adsorption capacity of Hg(II) by the membrane, and the isotherm is fitted by Langmuir model to estimate the theoretical maximum removal capacity of Hg(II) by the MXene/MCCNTs-SDS/CNF/NF-90 composite membrane.

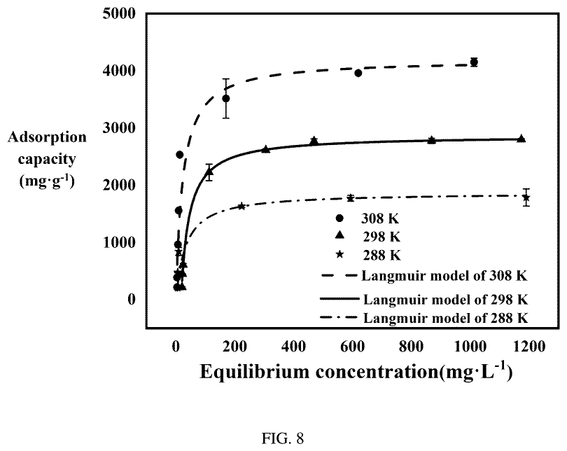

The saturated adsorption capacity diagram of MXene/MCCNTs-SDS/CNF/NF-90 composite nanofiltration membrane prepared in Embodiment 1 of the present disclosure is shown in FIG. 8. As shown in FIG. 8, the composite nanofiltration membrane shows saturated adsorption of Hg(II) up to 2869.6 mg/g at 298 K, 1872.6 mg/g at 288 K and 4197.6 mg/g at 308 K.

The present disclosure ensures efficient retention of NO₃⁻, SO₄²⁻ and NH₄⁺ while cooperatively accomplishing efficient adsorption of Hg(II) in the solution, thereby realizing the removal of Hg(II) while enriching (NH₄)₂SO₄ and NH₄NO₃, and the enriched (NH₄)₂SO₄ and NH₄NO₃ may be further evaporated and crystallized to generate nitrogen fertilizers, thus realizing the resourceful utilization of (NH₄)₂SO₄ and NH₄NO₃ with high economic efficiency.

The above describes only the preferred embodiments of this application, but the protection scope of this application is not limited to this. Any change or replacement that may be easily thought of by a person familiar with this technical field within the technical scope disclosed in this application should be included in the protection scope of this application. Therefore, the protection scope of this application should be based on the protection scope of the claims.

What is claimed is:

1. A preparation method of a composite nanofiltration membrane, comprising following steps: adding a cellulose nano fibrils colloid and a carboxylated carbon nanotubes-sodium dodecyl sulfate colloid into an MXene few layer dispersion solution to obtain a mixed dispersion solution, filtering the mixed dispersion solution in vacuum to a surface of a nanofiltration membrane, and standing and drying at room temperature to obtain a composite nanofiltration membrane; wherein
a preparation method of the MXene few layers dispersion solution comprises following steps: dissolving lithium fluoride with hydrochloric acid solution, then adding Ti₃AlC₂ for stirring treatment, followed by ultrasonic treatment and centrifugation, then adding ethanol into a precipitate to continue ultrasonic treatment, and centrifuging to obtain the MXene few layers dispersion solution.

2. The preparation method according to claim 1, wherein a concentration of the MXene few layers dispersion solution is 2 milligrams per milliliter, and a volume ratio of the MXene few layers dispersion solution to the carboxylated carbon nanotubes-sodium dodecyl sulfate colloid and the cellulose nano fibrils colloid is 5:4:1.

3. The preparation method according to claim 1, wherein a material-liquid ratio of the lithium fluoride, the Ti₃AlC₂ and the hydrochloric acid solution is 2 grams:2 grams:40 milliliter, and a concentration of the hydrochloric acid solution is 9 mole per liter.

4. The preparation method according to claim 1, wherein a stirring temperature of adding the Ti₃AlC₂ for stirring treatment is in a range of 30 degrees Celsius −35 degrees Celsius, a rotating speed is 450 revolutions per minute.

5. The preparation method according to claim 1, wherein after the stirring treatment, the ultrasonic treatment and centrifugation are carried out until a pH of a supernatant is higher than 6.

6. The preparation method according to claim 1, wherein a pressure of the filtering in vacuum is 0.5 mega pascal.

7. The preparation method according to claim 1, wherein the nanofiltration membrane is an NF-90 membrane.

8. A composite nanofiltration membrane prepared by the preparation method according to claim 1.

9. A method for adsorbing and removing mercury ions while intercepting ammonium sulfate and ammonium nitrate in desulfurization and denitrification slurry, wherein a nanofiltration membrane used in an interception process is the composite nanofiltration membrane according to claim 8.
